(19) United States
(12) Patent Application Publication
(10) Pub. No.: US 2014/0372088 A1
(43) Pub. Date: Dec. 18, 2014

(54) METHOD OF ANALYZING CONTAMINANT TRANSPORT UNDER CAUCHY BOUNDARY CONDITIONS USING IMPROVED LAGRANGIAN-EULERIAN METHOD

(71) Applicant: KOREA INSTITUTE OF GEOSCIENCE AND MINERAL RESOURCES, Daejeon (KR)

(72) Inventors: Heejun Suk, Daejeon (KR); Byung-Gon Chae, Daejeon (KR); Jung-Hae Choi, Daejeon (KR)

(21) Appl. No.: 13/971,260

(22) Filed: Aug. 20, 2013

(30) Foreign Application Priority Data
Jun. 12, 2013 (KR) 10-2013-0067203

(51) Int. Cl. G06G 7/57

(52) U.S. Cl. CPC G06G 7/57
USPC 703/2

(57) ABSTRACT

This invention relates to, in order to numerically analyze contaminant transport in groundwater, a method of analyzing contaminant transport under Cauchy boundary conditions using an improved Lagrangian-Eulerian method, wherein problems of a conventional Lagrangian-Eulerian method able to analyze only high Peclet numbers are solved, and which is configured to analyze a new numerical matrix constructed in such a manner that a Eulerian method is applied to an element adjacent to Cauchy boundary conditions and a conventional Lagrangian-Eulerian method is applied to an internal element, thereby enabling accurate numerical analysis of contaminant transport at various Peclet numbers including not only high Peclet numbers but also particularly low Peclet numbers under Cauchy boundary conditions.

### CROSS-REFERENCES TO RELATED APPLICATIONS

This patent application claims the benefit of priority from Korean Patent Application No. 10-2013-0067203, filed on Jun. 12, 2013, the contents of which are incorporated herein by reference in its entirety.

### BACKGROUND OF THE INVENTION

1. Field of the Invention

The present invention relates to a method of numerically analyzing contaminant transport in groundwater, and more particularly, to a method of analyzing contaminant transport under Cauchy boundary conditions using an improved Lagrangian-Eulerian method, wherein problems of a conventional Lagrangian-Eulerian method that is able to analyze only high Peclet numbers may be solved, thereby enabling accurate numerical analysis of contaminant transport at various Peclet numbers under Cauchy boundary conditions.

In addition, the present invention relates to a method of analyzing contaminant transport under total flow boundary conditions using an improved Lagrangian-Eulerian method, which is configured to analyze a new numerical matrix constructed in such a manner that a Eulerian method is applied to an element adjacent to Cauchy boundary conditions and a conventional Lagrangian-Eulerian method is applied to an internal element, thereby enabling accurate numerical analysis of contaminant transport at various Peclet numbers including not only high Peclet numbers but also particularly low Peclet numbers under Cauchy boundary conditions.

2. Description of the Related Art

A variety of methods have been conventionally proposed to numerically analyze groundwater flow.

However, contaminant transport in groundwater is not easy to analyze through numerical approach compared to groundwater flow.

This is because a partial differential equation for contaminant transport in groundwater is modified from a parabolic equation to a hyperbolic partial differential equation depending on the relative magnitude of advection and dispersion (Cited Reference 1).

A conventional numerical method for analyzing such contaminant transport started from an Eulerian method or a Lagrangian method.

More specifically, an Eulerian method is used to analyze a contaminant transport equation within lattices defined by a finite difference method or a finite element method. In the early 1980s, this method was already reported to be adapted for contaminant transport in which dispersion is dominant corresponding to low Peclet numbers (Cited References 2 to 4).

Whereas, in the case of contaminant transport in which advection is dominant corresponding to high Peclet numbers, difficulties in seeking numerical solutions from numerical vibration or numerical dispersion have been reported (Cited References 2 to 4), and various methods including high-order finite element techniques, upward finite element methods or finite difference methods, high-order Galerkin approximation methods, etc. have been proposed to solve such numerical difficulties including numerical vibration and numerical dispersion (Cited References 5 and 6).

Although numerical vibration may be eliminated using such methods, time intervals are considerably limited by Courant-Friedrichs-Lewy conditions (Cited References 7 and 8).

With the goal of these problems, an Eulerian-Lagrangian method appeared in the 1980s, and this method is used to analyze two components, that is, advection and dispersion, which are separated depending on the concentration (Cited References 7 to 10).

More specifically, this method is intended to analyze the concentration of the advection component using a particle tracking method and to analyze the concentration of the dispersion component using finite element or finite difference methods, but is disadvantageous because accuracy of the Lagrangian concentration is determined by a particle tracking method and a concentration interpolation method (Cited Reference 11).

As such, the latter problems may be solved via combination of forward and backward particle tracking methods, and tracking methods at maximum and minimum points, in the range where drastic changes in concentration occur.

Representative examples of methods having such features may include LEZOOM and EPCOF numerical methods and various other methods (Cited References 11 to 13).

Although all of the aforementioned methods are responsible for separately analyzing advection and dispersion components on the assumption that the dispersion differential terms of advection parameters are much lower than the advection/dispersion partial differential terms of dispersion parameters, these may be limitedly applied only at high Peclet numbers which indicate that advection is comparatively dominant, due to such an assumption.

Furthermore, conventional studies solved contaminant transport problems even under conditions where dispersion is dominant by means of the conventional Lagrangian-Eulerian method, but no numerical errors related thereto were stated.

Accordingly, in order to solve problems of conventional analysis methods for contaminant transport, an improved analysis method which enables accurate analysis of contaminant transport not only at high Peclet numbers but also at low Peclet numbers under Cauchy boundary conditions, would be preferable, but no method which satisfies such requirements has yet been introduced.

### CITED REFERENCES

1. Konikow, L. F., Reilly, T. E., Barlow, P. M., Voss, C. I., 2007. Chapter 23, Groundwater modeling. In: Delleur, J. (Eds.), The Handbook of Groundwater Engineering, CRC Press, Boca Raton, pp. 54.
2. Cooley, R. L., 1971. A finite difference method for unsteady flow in variably saturated porous media: application to a single pumping well. Water Resources Research 7, 1607-1625.
3. Freeze, R. A., 1971a. Three dimensional transient, saturated unsaturated flow in a groundwater basin. Water Resources Research 7, 347-366.
4. Freeze, R. A., 1971b. Influence of the unsaturated flow domain on seepage through earth dams. Water Resources Research 7, 929-941.
5. Price, H. S., Cavendish, J. C., Varga, R. S., 1968. Numerical methods of higher-order accuracy for diffusion-convection equations. Society of Petroleum engineers Journal, 293-300.
6. Van Genuchten, M. T., 1977. On the accuracy and efficiency of several numerical schemes for solving the convective dispersive equation. In: Gray, G., Pinder, G. F., Brebbia, C. A. (Eds), Finite Elements in Water Resources, Pentech, London. pp. 1.71-1.90.
7. Neuman, S. P. 1981. A Eulerian-Lagrangian numerical scheme for the dispersion-convection equation using conjugate space-time grids, J. Comput. Phys., 41(2), 270-294.
8. Neuman, S. P., 1984. Adaptive Eulerian-Lagrangian finite element method for advection-dispersion. International Journal for Numerical Methods in Engineering 20, 321-337.
9. Sorek, S., 1985. Eulerian-Lagrangian formulation for flow in soil, Advances in Water Resources 8, 118-120.
10. Sorek, S., Borisov, V., Yakirevich, A., 2000. Numerical modeling of coupled hydrological phenomena using the modified Eulerian-Lagrangian method, theory, modeling and field investigation. In: Zhang, D., Winter, C. L. (Eds), Hydrogeology: a special volume in honor of Shlomo P. Neuman's 60th Birthday, Geological Society of America, Special Paper 348, pp. 151-160.
11. Yeh, G. T., Chang, J. R., 1992. An exact peak capturing and oscillation free Scheme to solve advection-dispersion transport equations, Water Resources Research 28, 2937-2951.
12. Yeh, G. T. 1990. A Lagrangian-Eulerian method with zoomable hidden fine-mesh approach to solving advection-dispersion equations, Water Resour. Res, 26(6), 1133-1144.
13. Sorek, S., Braester, C., 1988. Eulerian-Lagrangian Formulation of the Equations for groundwater denitrification using bacterial activity. Advances in water resources 11(4), 162-169.
14. Bear, J. 1979. Hydraulics of Groundwater, 569. New York: McGraw-Hill.
15. Bear, J., and A. H.-D. Cheng. 2010. Modeling Groundwater Flow and Contaminant Transport, 834. Dordrecht: Springer.
16. Domenico, P. A., and F. W. Schwartz. 1998. Physical and Chemical Hydrogeology, 2nd ed., 506. New York: John Wiley & Sons, Inc.
17. Bredehoeft, J. D., and G. F. Pinder. 1973. Mass transport in flowing groundwater. Water Resources Research 9, no. 1: 194-210.

### SUMMARY OF THE INVENTION

Accordingly, the present invention has been made keeping in mind the above problems encountered in the related art, and an object of the present invention is to provide a method of analyzing contaminant transport under Cauchy boundary conditions using an improved Lagrangian-Eulerian method, wherein, in order to numerically analyze contaminant transport in groundwater, problems of a conventional Lagrangian-Eulerian able to analyze only high Peclet numbers may be solved, thereby enabling accurate numerical analysis of contaminant transport at various Peclet numbers under Cauchy boundary conditions.

Another object of the present invention is to provide a method of analyzing contaminant transport under Cauchy boundary conditions using an improved Lagrangian-Eulerian method, which is configured to analyze a new numerical matrix constructed in such a manner that an Eulerian method is applied to an element adjacent to Cauchy boundary conditions and a conventional Lagrangian-Eulerian method is applied to an internal element, thereby enabling accurate numerical analysis of contaminant transport at various Peclet numbers including not only high Peclet numbers but also particularly low Peclet numbers under Cauchy boundary conditions.

In order to accomplish the above objects, the present invention provides a method of analyzing contaminant transport under Cauchy boundary conditions using an improved Lagrangian-Eulerian method, which is configured to execute, on a computer, a series of processes for solving problems of a conventional Lagrangian-Eulerian method able to analyze only high Peclet numbers, by analyzing a new numerical matrix constructed in such a manner that an Eulerian method is applied to an element adjacent to the Cauchy boundary conditions and the conventional Lagrangian-Eulerian method is applied to an internal element, in order to numerically analyze contaminant transport in groundwater, wherein the series of processes comprise deriving a governing equation showing dispersion and advection of contaminant species from the law of conservation of mass; applying Cauchy boundary to the governing equation; performing numerical development by applying a Lagrangian-Eulerian method to an element or cell not present on the Cauchy boundary; and performing numerical development by applying an Eulerian method to an element or cell present on the Cauchy boundary, thus enabling accurate numerical analysis of contaminant transport not only at high Peclet numbers but also at low Peclet numbers under the Cauchy boundary conditions.

The method may further comprise performing a simulation test to verify accuracy of numerical analysis, after performing the numerical development.

Also, deriving the governing equation may be carried out such that, assuming that groundwater flows only in an x-axis direction and θ is constant in an entire region, when θ is a volume of water per unit volume, C is a concentration of a solute, V is a seepage velocity, D is a dispersion coefficient, and a material derivative with respect to a concentration is defined as follows:

$$\begin{matrix}\frac{DC}{Dt} = \frac{\partial C}{\partial t} + \frac{\partial C}{\partial x} \frac{Dx}{Dt} \\ = \frac{\partial C}{\partial t} + \frac{\partial C}{\partial x} V\end{matrix}$$

the governing equation is determined by the following equation:

$$\frac{DC}{Dt} + C \frac{\partial V}{\partial x} - \frac{\partial }{\partial x} [ D \frac{\partial C}{\partial x} ] = 0$$

wherein C is not a concentration depending on time at a predetermined point but is a concentration depending on time in particles moving at a velocity V.

Further, in deriving the governing equation, an initial condition and a boundary condition for the governing equation may be represented by the following equations:

$$C ( x , t ) {\vert}_{t = 0} = F ( x )$$

$$VC ( x , t ) - D \frac{\partial C ( x , t )}{\partial x} {\vert}_{x = 0} = V ( x = 0 , t ) f ( t )$$

$$D \frac{\partial C ( x , t )}{\partial x} {\vert}_{x = L} = 0$$

wherein F(x) is an initial concentration, f(t) is a concentration of a solute introduced through the Cauchy boundary, and L is a length of a medium.

Also, performing the numerical development by applying the Lagrangian-Eulerian method may be carried out by the following equation:

$$( \frac{[ M ]}{δ t ( {x}^{*} )} + θ ( [ S ] + [ V ] ) ) \{ {C}^{n + 1} \} = ( \frac{[ M ]}{δ t ( {x}^{*} )} - ( 1 - θ ) ( [ S ] + [ V ] ) ) \{ {C}^{*} \} + \{ B \}$$

wherein δt(x*) is a particle tracking time related to x*, θ is a time integral factor, {Cⁿ⁺¹} is a concentration vector at a current time, {C*} is a Lagrangian concentration vector, [M] is a matrix calculated from time differential, [S] is a matrix calculated from a dispersion term, [V] is a matrix calculated from a velocity term, and {B} is a vector related to boundary upon using a Eulerian-Lagrangian equation.

Further, in performing the numerical development by applying the Lagrangian-Eulerian method, [M], [S], [V] and {B} may be calculated by the following equations:

$${M}_{ij} = {\sum }_{e ∈ {M}_{e}}^{ } {\int }_{L}^{ } {N}_{α}^{e} {N}_{β}^{e} d x$$

$${S}_{ij} = {\sum }_{e ∈ {M}_{e}}^{ } {\int }_{L}^{ } D \frac{d {N}_{α}^{e}}{d x} \frac{d {N}_{β}^{e}}{d x} d x$$

$${V}_{ij} = {\sum }_{e ∈ {M}_{e}}^{ } {\int }_{L}^{ } ( \frac{\partial V}{\partial x} ) {N}_{α}^{e } {N}_{β}^{e} d x$$

$${B}_{i} = {\sum }_{e ∈ {N}_{se}}^{ } {N}_{α}^{e} \hat{n} \cdot ( D \frac{\partial C}{\partial x} )$$

wherein Mₑ indicates a set of elements having local nodes α-β consistent with nodes i-j, Nₛₑ indicates a set of element boundary surfaces having a local node α consistent with a node i, and N_{α}^{e} is a local Galerkin weighting function of an element e.

Also, performing the numerical development by applying the Eulerian method to the element or cell present on the Cauchy boundary may be carried out by the following equation:

$$( \frac{[ M ]}{Δ t} + θ ( [ S ] + [ E ] ) ) \{ {C}^{n + 1} \} = ( \frac{[ M ]}{Δ t} - ( 1 - θ ) ( [ S ] + [ E ] ) ) \{ {C}^{n} \} + \{ F \}$$

wherein Δt is a time interval, {Cⁿ} is a concentration vector at a past time, [E] is a matrix calculated from a velocity term, and {F} is a vector related to a case of using an Eulerian equation.

Further, in performing the numerical development by applying the Eulerian method, [E] and {F} may be calculated by the following equations:

$${E}_{ij} = {\sum }_{e ∈ {M}_{e}}^{ } {\int }_{L}^{ } V \frac{\partial {W}_{i}}{\partial x} {N}_{j} d x$$

$${F}_{i} = - {\sum }_{e ∈ {N}_{se}}^{ } {N}_{α}^{e} \hat{n} \cdot ( VC - D \frac{\partial C}{\partial x} ) .$$

In addition, the present invention provides a computer-readable recording medium, having recorded therein a program for executing a series of processes which enable accurate numerical analysis of contaminant transport not only at high Peclet numbers but also at low Peclet numbers under Cauchy boundary conditions, through a computer, using the above method.

In addition, the present invention provides an analysis system, which is configured to execute the above method so as to enable accurate numerical analysis of contaminant transport not only at high Peclet numbers but also at low Peclet numbers under Cauchy boundary conditions.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates the law of conservation of mass;

FIG. 2 illustrates the whole concept of a process of analyzing contaminant transport under Cauchy boundary conditions using an improved Lagrangian-Eulerian method according to the present invention;

FIG. 3 is a flowchart schematically illustrating a process of analyzing contaminant transport under Cauchy boundary conditions using an improved Lagrangian-Eulerian method according to an embodiment of the present invention;

FIG. 4 is a table illustrating input data applied to numerical simulation to verify performance of the process of analyzing contaminant transport under Cauchy boundary conditions using an improved Lagrangian-Eulerian method according to the present invention; and

FIGS. 5A to 5D are graphs illustrating the results of numerical simulation based on the input data of FIG. 4.

### DESCRIPTION OF SPECIFIC EMBODIMENTS

Hereinafter, a detailed description will be given of a method of analyzing contaminant transport under Cauchy boundary conditions using an improved Lagrangian-Eulerian method according to specific embodiments of the present invention, with reference to the appended drawings.

Herein, the following description is set forth to merely illustrate, but is not to be construed as limiting, the present invention.

Furthermore, in the description of the present invention, when it is determined that the detailed description of the related art would obscure the gist of the present invention, the description thereof will be omitted.

The present invention pertains to a method of analyzing contaminant transport under Cauchy boundary conditions using an improved Lagrangian-Eulerian method, which may solve problems of a conventional Lagrangian-Eulerian method able to analyze only high Peclet numbers in conventional methods for numerically analyzing contaminant transport in groundwater, thereby enabling accurate numerical analysis of contaminant transport at various Peclet numbers under Cauchy boundary conditions, as will be described later.

Also, the present invention pertains to a method of analyzing contaminant transport under Cauchy boundary conditions using an improved Lagrangian-Eulerian method, which is configured to analyze a new numerical matrix constructed in such a manner that an Eulerian method is applied to an element adjacent to Cauchy boundary conditions and a conventional Lagrangian-Eulerian method is applied to an internal element, thereby enabling accurate numerical analysis of contaminant transport at various Peclet numbers including not only high Peclet numbers but also particularly low Peclet numbers under Cauchy boundary conditions.

With reference to the appended drawings, the method of analyzing contaminant transport under Cauchy boundary conditions using an improved Lagrangian-Eulerian method according to specific embodiments of the present invention is described below.

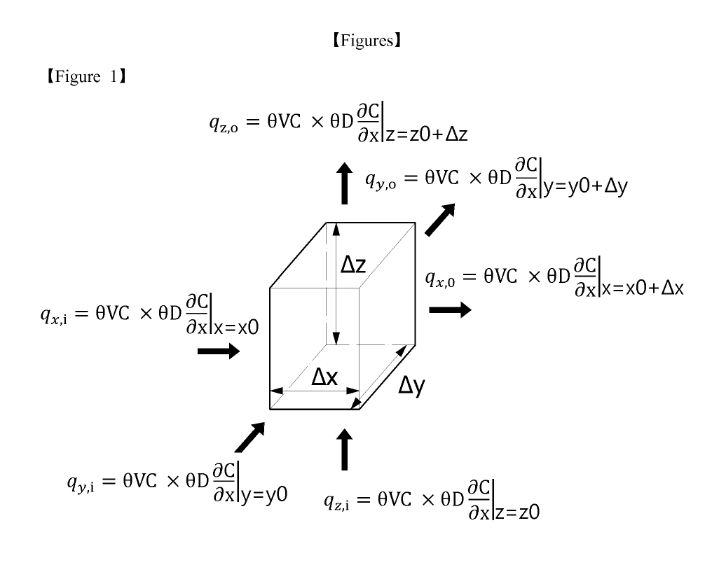

Referring to FIG. 1, a governing equation for analyzing a contaminant transport equation is first described.

FIG. 1 illustrates the law of conservation of mass.

More specifically, an equation which shows dispersion and advection of soluble non-reactive contaminant species in an aquifer is derived from the law of conservation of mass (Cited References 14 to 17).

As illustrated in FIG. 1, the law of conservation of mass means that a difference in the mass of a solute which is added to or removed from the unit volume of an aquifer for a given unit time interval is equal to the increased or decreased mass of the solute stored in the unit volume for the corresponding time interval.

Therefore, when changes in mass per unit volume per unit time are represented by Equation 1 below, the difference in mass which is added to or removed from unit volume per unit time may be represented by Equation 2 below.

$$\begin{matrix}Change in mass per unit volume per unit time = \frac{\partial ( θ C )}{\partial t} & [ Equation 1 ] \\ Difference in mass added to or removed from unit volume per unit time = ( {q}_{x , 0} - {q}_{x , i} ) \frac{Δ y Δ z}{Δ x Δ y Δ z} + ( {q}_{y , 0} - {q}_{y , i} ) \frac{Δ x Δ z}{Δ x Δ y Δ z} + ( {q}_{z , 0} + {q}_{z , i} ) \frac{Δ x Δ y }{Δ x Δ y Δ z} & [ Equation 2 ]\end{matrix}$$

Thus, the law of conservation of mass may be shown as in Equation 3 below.

$$\begin{matrix}\frac{\partial ( θ C )}{\partial t} = \frac{\partial {q}_{x}}{\partial x} + \frac{\partial {q}_{y}}{\partial y} + \frac{\partial {q}_{z}}{\partial z} \\ = ∇ \cdot q \\ = ∇ \cdot [ θ VC - θ D \cdot ∇ C ]\end{matrix} \qquad [ Equation 3 ]$$

In the equations, θ is the volume of water per unit volume, C is the concentration of the solute, V is the seepage velocity, and D is the dispersion coefficient.

Also, assuming that groundwater flows only in the x-axis direction and θ is constant in the entire region, the governing equation may be represented by Equation 4 below.

$$\frac{\partial C}{\partial t} + \frac{\partial }{\partial x} [ VC ] - \frac{\partial }{\partial x} [ D \frac{\partial C}{\partial x} ] = 0 \qquad [ Equation 4 ]$$

Furthermore, a material derivative with respect to the concentration may be defined as in Equation 5 below.

$$\begin{matrix}\frac{DC}{Dt} = \frac{\partial C}{\partial t} + \frac{\partial C}{\partial x} \frac{Dx}{Dt} \\ = \frac{\partial C}{\partial t} + \frac{\partial C}{\partial x} V\end{matrix} \qquad [ Equation 5 ]$$

Accordingly, when Equation 5 is substituted into Equation 4, the governing equation is summarized as in Equation 6 below.

$$\frac{DC}{Dt} + C \frac{\partial V}{\partial x} - \frac{\partial }{\partial x} [ D \frac{\partial C}{\partial x} ] = 0 \qquad [ Equation 6 ]$$

In the equations, C is not the concentration depending on time at a predetermined point, but is the concentration depending on time in the particles which move at the velocity V.

The initial and boundary conditions for the governing equation shown in Equation 6 are represented by Equations 7 to 9 below.

$$\begin{matrix}C ( x , t ) {\vert}_{t = 0} = F ( x ) & [ Equation 7 ] \\ VC ( x , t ) - D \frac{\partial C ( x , t )}{\partial x} {\vert}_{x = 0} = V ( x = 0 , t ) f ( t ) & [ Equation 8 ] \\ D \frac{\partial C ( x , t )}{\partial x} {\vert}_{x = L} = 0 & [ Equation 9 ]\end{matrix}$$

In these equations, F(x) is the initial concentration, f(t) is the concentration of a solute introduced through Cauchy boundary, and L is the length of a medium.

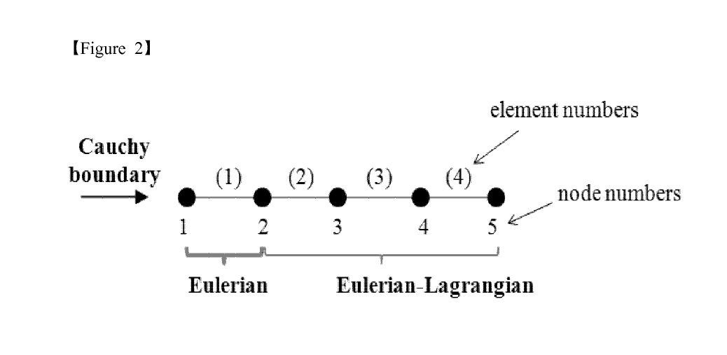

With reference to FIG. 2, numerical development of the governing equation as above is described.

FIG. 2 illustrates the whole concept of the process of analyzing contaminant transport under Cauchy boundary conditions using an improved Lagrangian-Eulerian method according to the present invention.

More specifically, the method of analyzing contaminant transport under Cauchy boundary conditions using an improved Lagrangian-Eulerian method according to the present invention is configured such that, when Cauchy boundary is applied using an Eulerian-Lagrangian method, an element or cell on the Cauchy boundary is calculated using an Eulerian method and the other elements or cells are calculated using a Eulerian-Lagrangian method.

As such, FIG. 2 illustrates the case where a finite element method (FEM) is applied.

With reference to FIG. 2, numerical development upon using FEM is described below, but the numerical method according to the present invention may be conceptually the same as in the case of using a finite difference method (FDM).

More specifically, in order to apply a Eulerian-Lagrangian method, nodes 2˜5 of FIG. 2 are subjected to particle tracking, using Equation 10 below.

$$\begin{matrix}{C}_{i}^{*} = {\sum }_{j = 1}^{5} {C}_{j}^{n} {N}_{j} ( {x}_{i}^{*} ) & i = 2 , … , 5\end{matrix} \qquad [ Equation 10 ]$$

In this equation, Cᵢ* is the concentration of particles calculated from the node i via particle tracking, Cⱼⁿ is the concentration at the node j in the old time step, Nⱼ(xᵢ*) is the base function related to the node xⱼ at the position xᵢ*, and xᵢ* is calculated by Equation 11 below.

xᵢ*=xᵢ−∫ₜ_{ⁿ}^{t}^{ⁿ⁺¹}V[x(t),t]dt i=2, . . . 5 [Equation 11]

In this equation, tⁿ⁺¹ is the current time, tⁿ is the past time, and xᵢ* is the position of particles at time tⁿ when particles reach the node xᵢ via particle tracking at time tⁿ⁺¹.

Also, as represented in the following Equation 12, when the governing equation of Equation 6 is multiplied by an appropriate weighting function and then integrated with respect to the interest region, the residual may become zero.

$${\int }_{L}^{ } {N}_{i} \{ \frac{D \hat{C}}{Dt} + \hat{C} \frac{\partial V}{\partial x} - \frac{\partial }{\partial x} [ D \frac{\partial \hat{C}}{\partial x} ] \} d x = 0 \qquad [ Equation 12 ]$$

In this equation, Nᵢ is the Galerkin weighting function, and Ĉ(x,t) is defined as in Equation 13 below.

$$\hat{C} ( x , t ) = {\sum }_{j = 1}^{5} {N}_{j} ( x ) {C}_{j} ( t ) \qquad [ Equation 13 ]$$

As such, when Green's first identity is used, Equation 12 may be represented by Equation 14 below.

$${\int }_{L}^{ } {N}_{i} \frac{D \hat{C}}{Dt} d x + {\int }_{L}^{ } {N}_{i} \hat{C} \frac{\partial V}{\partial x} d x - {N}_{i} \hat{n} \cdot ( D \frac{\partial C}{\partial x} ) + {\int }_{L}^{ } \frac{\partial {N}_{i}}{\partial x} \frac{\partial \hat{C}}{\partial x} d x = 0 \qquad [ Equation 14 ]$$

Further, when Equation 13 is substituted into Equation 14, the following Equation 15 is obtained.

$${\sum }_{j = 1}^{5} {\int }_{L}^{ } {N}_{i} {N}_{j} d x \frac{{DC}_{j}}{Dt} + {\sum }_{j = 1}^{5} {\int }_{L}^{ } {N}_{i} {N}_{j} \frac{\partial V}{\partial x} d {xC}_{j} - {N}_{i} \hat{n} \cdot ( D \frac{\partial C}{\partial x} ) + {\sum }_{j = 1}^{5} {\int }_{L}^{ } D \frac{\partial {N}_{i}}{\partial x} \frac{\partial {N}_{j}}{\partial x} d {xC}_{j} = 0 \qquad [ Equation 15 ]$$

When Equation 15 is expressed as a matrix, the following Equation 16 is obtained.

$$( \frac{[ M ]}{δ t ( {x}^{*} )} + θ ( [ S ] + [ V ] ) ) \{ {C}^{n + 1} \} = ( \frac{[ M ]}{δ t ( {x}^{*} )} - ( 1 - θ ) ( [ S ] + [ V ] ) ) \{ {C}^{*} \} + \{ B \} \qquad [ Equation 16 ]$$

In this equation, δt(x*) is the particle tracking time related to x*, θ is the time integral factor, {Cⁿ⁺¹} is the concentration vector at the current time, {C*} is the Lagrangian concentration vector, [M] is the matrix calculated from time differential, [S] is the matrix calculated from the dispersion term, [V] is the matrix calculated from the velocity term, {B} is the vector related to the boundary when using the Eulerian-Lagrangian equation, and [M], [S], [V] and {B} are defined as follows.

$$\begin{matrix}{M}_{ij} = {\sum }_{e ∈ {M}_{e}}^{ } {\int }_{L}^{ } {N}_{α}^{e} {N}_{β}^{e} d x & [ Equation 17 ] \\ {S}_{ij} = {\sum }_{e ∈ {M}_{e}}^{ } {\int }_{L}^{ } D \frac{d {N}_{α}^{e}}{d x} \frac{d {N}_{β}^{e}}{d x} d x & [ Equation 18 ] \\ {V}_{ij} = {\sum }_{e ∈ {M}_{e}}^{ } {\int }_{L}^{ } ( \frac{\partial V}{\partial x} ) {N}_{a}^{e} {N}_{β}^{e} d x & [ Equation 19 ] \\ {B}_{i} = {\sum }_{e ∈ {N}_{se}}^{ } {N}_{α}^{e} \hat{n} \cdot ( D \frac{\partial C}{\partial x} ) & [ Equation 20 ]\end{matrix}$$

In these equations, Mₑ indicates the set of elements having local nodes α-β consistent with nodes i-j, Nₛₑ indicates the set of element boundary surfaces having the local node α consistent with the node i, and N_{α}^{e} is the local Galerkin weighting function of the element e.

Specifically, if the one dimension as shown in FIG. 2 is supposed and all the elements have the same length and the constant velocity and are lumped, [M], [S] and [V] are calculated as follows.

$$\begin{matrix}[ {M}^{( e )} ] = [ \begin{matrix}\frac{1}{2} {Δ}_{x} & 0 \\ 0 & \frac{1}{2} {Δ}_{x}\end{matrix} ] & [ Equation 21 ] \\ [ {S}^{( e )} ] = \frac{D}{{Δ}_{x}} [ \begin{matrix}1 & - 1 \\ - 1 & 1\end{matrix} ] & [ Equation 22 ] \\ [ {V}^{( e )} ] = [ \begin{matrix}0 & 0 \\ 0 & 0\end{matrix} ] & [ Equation 23 ]\end{matrix}$$

As such, it is noted that [V] becomes a zero matrix because the velocity is supposed to be constant.

As shown in FIG. 2, the Eulerian-Lagrangian method is applied to all the elements which are not adjacent to the Cauchy boundary, and Equations 21 to 23 are used for all the elements to which the Eulerian-Lagrangian method is applied.

Thus, Equation 16, which is the matrix equation for the elements 2˜4 of FIG. 2 corresponding to the elements to which the Eulerian-Lagrangian method is applied, is simply represented as follows.

[A]{C}={R} [Equation 24]

In this equation, [A] and {R} are defined as follows.

$$\begin{matrix}[ A ] = \{ \frac{[ M ]}{δ t ( {x}^{*} )} + θ ( [ S ] + [ V ] ) \} & [ Equation 25 ] \\ \{ R \} = \{ \frac{[ M ]}{δ t ( {x}^{*} )} - ( 1 - θ ) ( [ S ] + [ V ] ) \} \{ {C}^{*} \} + \{ B \} & [ Equation 26 ]\end{matrix}$$

In addition, the case where the Eulerian method is applied is described below.

As shown in FIG. 2, the Eulerian method is applied to the element 1 directly adjacent to the Cauchy boundary, and the governing equation for the Eulerian method is shown as in Equation 4.

Thus, when FEM is applied to the case of using the Eulerian method, the following equation is obtained.

$${\int }_{L}^{ } {N}_{i} \{ \frac{\partial \hat{C}}{\partial t} + \frac{\partial }{\partial x} [ V \hat{C} ] - \frac{\partial }{\partial x} [ D \frac{\partial \hat{C}}{\partial x} ] \} d x = 0 \qquad [ Equation 27 ]$$

Further, when Green's first identity is applied, Equation 27 is as follows.

$${\int }_{L}^{ } {N}_{i} \frac{\partial \hat{C}}{\partial t} d x + {N}_{i} \hat{n} \cdot ( VC ) - {\int }_{L}^{ } \frac{\partial {W}_{i}}{\partial x} \cdot V \hat{C} d x - {N}_{i} \hat{n} \cdot ( D \frac{\partial C}{\partial x} ) + {\int }_{L}^{ } \frac{\partial {N}_{i}}{\partial x} \frac{\partial \hat{C}}{\partial x} d x = 0 \qquad [ Equation 28 ]$$

In this equation, Wᵢ is the upstream weighting function.

Moreover, when Equation 13 is substituted into Equation 28, the following equation is obtained.

$${\sum }_{j = 1}^{5} {\int }_{L}^{ } {N}_{i} {N}_{j} d x \frac{\partial {C}_{j}}{\partial t} - {\sum }_{j = 1}^{5} {\int }_{L}^{ } V \frac{\partial {W}_{i}}{\partial x} {N}_{j} d {xC}_{j} + {\sum }_{j = 1}^{5} {\int }_{L}^{ } D \frac{\partial {N}_{i}}{\partial x} \frac{\partial {N}_{j}}{\partial x} d {xC}_{j} + {N}_{i} \hat{n} \cdot ( VC - D \frac{\partial C}{\partial x} ) = 0 \qquad [ Equation 29 ]$$

Also, when Equation 29 is expressed as a matrix, the following equation is obtained.

$$( \frac{[ M ]}{{Δ}_{t}} + θ ( [ S ] + [ E ] ) ) \{ {C}^{n + 1} \} = ( \frac{[ M ]}{{Δ}_{t}} - ( 1 - θ ) ( [ S ] + [ E ] ) ) \{ {C}^{n} \} + \{ F \} \qquad [ Equation 30 ]$$

In this equation, Δt is the time interval, {Cⁿ} is the concentration vector at the past time, [E] is the matrix calculated from the velocity term, {F} is the vector related to the case of using a Eulerian equation, and [E] and {F} are defined as follows.

$${E}_{ij} = {\sum }_{e ∈ {M}_{e}}^{ } {\int }_{L}^{ } \frac{V \partial {W}_{α}^{e}}{\partial x} {N}_{β}^{e} d x \qquad [ Equation 31 ]$$

(Where, W_{α}^{e} is an upstream weighting function of an element e.)

$${F}_{i} = - {\sum }_{e ∈ {N}_{α}}^{ } {N}_{α}^{e} \hat{n} \cdot ( VC - D \frac{\partial C}{\partial x} ) \qquad [ Equation 32 ]$$

As mentioned above, if one dimension is supposed and the elements have the same length and the constant velocity, [E] is calculated as follows.

$$[ {E}^{( e )} ] = \frac{V}{2} [ \begin{matrix}1 & 1 \\ - 1 & - 1\end{matrix} ] \qquad [ Equation 33 ]$$

Thus, Equation 30, which is the matrix equation for the element e=1 of FIG. 2 corresponding to the element to which the Eulerian method is applied, may be simply represented as follows.

[D]{C}={G} [Equation 34]

In this equation, [D] and {G} are calculated as follows.

$$\begin{matrix}[ D ] = \{ \frac{[ M ]}{{Δ}_{t}} + θ ( [ S ] + [ E ] ) \} & [ Equation 35 ] \\ \{ G \} = \{ \frac{[ M ]}{{Δ}_{t}} - ( 1 - θ ) ( [ S ] + [ E ] ) \} \{ {C}^{n} \} + \{ F \} & [ Equation 36 ]\end{matrix}$$

Thus, as shown in FIG. 2, the matrix equation for the element 1 using the Eulerian method and the matrix equations for the elements 2 to 4 using the Eulerian-Lagrangian method are represented together as follows.

$$( \begin{matrix}{D}_{11}^{( 1 )} & {D}_{12}^{( 1 )} & 0 & 0 & 0 \\ {D}_{21}^{( 1 )} & {D}_{22}^{( 1 )} + {A}_{22}^{( 2 )} & {A}_{23}^{( 2 )} & 0 & 0 \\ 0 & {A}_{32}^{( 2 )} & {A}_{33}^{( 2 )} + {A}_{33}^{( 3 )} & {A}_{34}^{( 3 )} & 0 \\ 0 & 0 & {A}_{( 43 )}^{3} & {A}_{( 44 )}^{3} + {A}_{( 44 )}^{4} & {A}_{45}^{( 4 )} \\ 0 & 0 & 0 & {A}_{54}^{( 4 )} & {A}_{55}^{( 4 )}\end{matrix} ) \{ \begin{matrix}{C}_{1}^{n + 1} \\ {C}_{2}^{n + 1} \\ {C}_{3}^{n + 1} \\ {C}_{4}^{n + 1} \\ {C}_{5}^{n + 1}\end{matrix} \} = \{ \begin{matrix}{G}_{1}^{( 1 )} \\ {G}_{2}^{( 1 )} + {R}_{2}^{( 2 )} \\ {R}_{( 3 )}^{2} + {R}_{3}^{( 3 )} \\ {R}_{4}^{( 3 )} + {R}_{4}^{( 4 )} \\ {R}_{5}^{( 4 )} \end{matrix} \} \qquad [ Equation 37 ]$$

As shown in FIG. 2, the internal nodes (i=3, 4) to which only the Eulerian-Lagrangian method is applied may be represented as follows using Equations 21 to 24 and 37 on the assumption that θ equals to 1.

H_{i,i-1}Cᵢ₋₁ⁿ⁺¹+H_{i,i}Cᵢⁿ⁺¹+H_{i,i+1}Cᵢ₊₁ⁿ⁺¹═Zᵢ i=3,4 [Equation 38]

As such, H_{i,i-1}, H_{i,i}, H_{i,i+1} and Zᵢ are as follows.

$$\begin{matrix}\begin{matrix}{H}_{i , i - 1} = {A}_{i , i - 1}^{( i - 1 )} \\ = \frac{{M}_{i , i - 1}^{( i - 1 )}}{δ t ( {x}^{*} )} + {S}_{i , i - 1}^{( i - 1 )} + {V}_{i , i - 1}^{( i - 1 )} \\ = - \frac{D}{Δ x}\end{matrix} & [ Equation 39 ] \\ \begin{matrix}{H}_{i , i} = {A}_{i , i}^{( i - 1 )} + {A}_{i , i}^{( i )} \\ = \frac{{M}_{i , i}^{( i - 1 )} + {M}_{i , i}^{( i )}}{δ t ( {x}^{*} )} + {S}_{i , i}^{( i - 1 )} + {S}_{i , i}^{( i )} + {V}_{i , i}^{( i - 1 )} + {V}_{i , i}^{( i )} \\ = \frac{Δ x}{δ t ( {x}^{*} )} + \frac{2 D}{Δ x}\end{matrix} & [ Equation 40 ] \\ \begin{matrix}{H}_{i , i + 1} = {A}_{i , i + 1}^{( i )} \\ = \frac{{M}_{i , i + 1}^{( i )}}{δ t ( {x}^{*} )} + {S}_{i , i + 1}^{( i )} + {V}_{i , i + 1}^{( i )} \\ = - \frac{D}{Δ x}\end{matrix} & [ Equation 41 ] \\ \begin{matrix}{Z}_{i} = {R}_{i}^{( i - 1 )} + {R}_{i}^{( i )} \\ = \frac{{M}_{i , i + 1}^{( i - 1 )}}{δ t ( {x}^{*} )} {C}_{i - 1}^{*} + [ \begin{matrix}\frac{{M}_{i , i}^{( i - 1 )}}{δ t ( {x}^{*} )} + \\ \frac{{M}_{i , i}^{( i )}}{δ t ( {x}^{*} )}\end{matrix} ] {C}_{i}^{*} + \frac{{M}_{i , i + 1}^{( i )}}{δ t ( {x}^{*} )} {C}_{i + 1}^{*} \\ = \frac{Δ x}{δ t ( {x}^{*} )} {C}_{i}^{*}\end{matrix} & [ Equation 42 ]\end{matrix}$$

Also, the equation for the first node (i=1) using the Eulerian method due to the application of the Cauchy boundary may be represented as follows using Equations 21, 22, 33, 34 and 37.

H_{1,1}C₁ⁿ⁺¹+H_{1,2}C₂ⁿ⁺¹═Z₁ [Equation 43]

As such, H_{1,1}, H_{1,2} and Z₁ are as follows.

$$\begin{matrix}\begin{matrix}{H}_{1 , 1} = {D}_{1 , 1}^{( 1 )} \\ = \frac{{M}_{1 , 1}^{( 1 )}}{Δ t} + {S}_{1 , 1}^{( 1 )} + {E}_{1 , 1}^{( 1 )} \\ = \frac{1}{2} \frac{Δ x}{Δ t} + \frac{D}{Δ x} + \frac{V}{2}\end{matrix} & [ Equation 44 ] \\ \begin{matrix}{H}_{1 , 2} = {D}_{1 , 2}^{( 1 )} \\ = \frac{{M}_{1 , 2}^{( 1 )}}{Δ t} + {S}_{1 , 2}^{( 1 )} + {E}_{1 , 2}^{( 1 )} \\ = - \frac{D}{Δ x} + \frac{V}{2}\end{matrix} & [ Equation 45 ] \\ \begin{matrix}{Z}_{1} = {G}_{1}^{( 1 )} \\ = \frac{{M}_{1 , 1}^{( 1 )}}{Δ t} {C}_{1}^{n} + \frac{{M}_{1 , 2}^{( 1 )}}{Δ t} {C}_{2}^{n} + {F}_{1}^{( 1 )} \\ = \frac{1}{2} \frac{Δ x}{Δ t} {C}_{1}^{n} - {N}_{1}^{( 1 )} \hat{n} \cdot ( VC - D \frac{\partial C}{\partial x} )\end{matrix} & [ Equation 46 ]\end{matrix}$$

On the other hand, as shown in FIG. 2, the node 2 (i=2) to which both the Eulerian method and the Eulerian-Lagrangian method are applied may be represented as follows using Equation 21 to 24, 33, 34 and 37.

H_{2,1}C₁ⁿ⁺¹+H_{2,2}C₂ⁿ⁺¹+H_{2,3}C₃ⁿ⁺¹═Z₂ [Equation 47]

As such, H_{2,1}, H_{2,2}, H_{2,3} and Z₂ are as follows.

$$\begin{matrix}\begin{matrix}{H}_{2 , 1} = {D}_{2 , 1}^{( 1 )} \\ = \frac{{M}_{2 , 1}^{( 1 )}}{Δ t} + {S}_{2 , 1}^{( 1 )} + {E}_{2 , 1}^{( 1 )} \\ = - \frac{D}{Δ x} - \frac{V}{2}\end{matrix} & [ Equation 48 ] \\ \begin{matrix}{H}_{2 , 2} = {D}_{2 , 2}^{( 1 )} + {A}_{2 , 2}^{( 2 )} \\ = \frac{{M}_{2 , 2}^{( 1 )}}{Δ t} + \frac{{M}_{2 , 2}^{( 2 )}}{δ t ( {x}^{*} )} + {S}_{2 , 2}^{( 1 )} + {S}_{2 , 2}^{( 2 )} + {E}_{2 , 2}^{( 1 )} + {V}_{2 , 2}^{( 2 )} \\ = \frac{1}{2} \frac{Δ x}{Δ t} + \frac{1}{2} \frac{Δ x}{δ t ( {x}^{*} )} + \frac{2 D}{Δ x} - \frac{V}{2}\end{matrix} & [ Equation 49 ] \\ \begin{matrix}{H}_{2 , 3} = {A}_{2 , 3}^{( 2 )} \\ = \frac{{M}_{2 , 3}^{( 2 )}}{δ t ( {x}^{*} )} + {S}_{2 , 3}^{( 2 )} + {V}_{2 , 3}^{( 2 )} \\ = - \frac{D}{Δ x}\end{matrix} & [ Equation 50 ] \\ \begin{matrix}{Z}_{2} = {G}_{2}^{( 1 )} + {R}_{2}^{( 2 )} \\ = \frac{{M}_{2 , 1}^{( 1 )}}{Δ t} {C}_{1}^{n} + \frac{{M}_{2 , 2}^{( 1 )}}{Δ t} {C}_{2}^{n} + {F}_{2}^{( 1 )} + \frac{{M}_{2 , 2}^{( 2 )}}{δ t ( {x}^{*} )} {C}_{2}^{*} + \\ \frac{{M}_{2 , 3}^{( 2 )}}{δ t ( {x}^{*} )} {C}_{3}^{*} + {B}_{2}^{( 2 )} \\ = \frac{1}{2} \frac{Δ x}{Δ t} {C}_{2}^{n} + \frac{1}{2} \frac{Δ x}{δ t ( {x}^{*} )} {C}_{2}^{*} + {N}_{2}^{( 1 )} \hat{n} \cdot ( VC )\end{matrix} & [ Equation 51 ]\end{matrix}$$

In Equation 51, \hat{n}V in N₂⁽¹⁾\hat{n}(VC) may be previously determined, but C cannot be previously determined, and thus Equation 51 should be modified as follows.

H_{2,1}C₁ⁿ⁺¹+H′_{2,2}C₂ⁿ⁺¹+H_{2,3}C₃ⁿ⁺¹═Z′₂ [Equation 52]

As such, H′_{2,2} and Z′₂ are as follows.

$$\begin{matrix}{H}_{2 , 2}^{′} = {H}_{2 , 2} - {N}_{2}^{( 1 )} \hat{n} \cdot V & [ Equation 53 ] \\ \begin{matrix}{Z}_{2}^{′} = {Z}_{2} - {N}_{2}^{( 1 )} \hat{n} \cdot ( VC ) \\ = \frac{1}{2} \frac{Δ x}{Δ t} {C}_{2}^{n} + \frac{1}{2} \frac{Δ x}{δ t ( {x}^{*} )} {C}_{2}^{*}\end{matrix} & [ Equation 54 ]\end{matrix}$$

In Equation 54, in the case where particles positioned at the node 2 reach the Cauchy boundary before Δt, C₂* is as follows.

C₂*=(1−φ₂)C₁ⁿ⁺¹+φ₂C₁ⁿ [Equation 55]

In this equation,

$${φ}_{2} = \frac{δ t ( {x}_{2}^{*} )}{Δ t} .$$

Hence, when Equation 55 is substituted into Equation 54, the following equation is obtained.

$${Z}_{2}^{′} = \frac{1}{2} \frac{Δ x}{Δ t} {C}_{2}^{n} + \frac{1}{2} \frac{Δ x}{δ t ( {x}^{*} )} [ ( 1 - {φ}_{2} ) {C}_{1}^{n + 1} + {φ}_{2} {C}_{1}^{n} ] \qquad [ Equation 56 ]$$

However, in Equation 56, C₁ⁿ⁺¹ is the unknown number. Hence, Equation 52 should be modified as follows.

H′_{2,1}C₁ⁿ⁺¹+H′_{2,2}C₂ⁿ⁺¹+H_{2,3}C₃ⁿ⁺¹═Z″₂ [Equation 57]

As such, H′_{2,1} and Z″₂ are as follows.

$$\begin{matrix}{H}_{2 , 1}^{′} = {H}_{2 , 1} - \frac{1}{2} \frac{Δ x}{δ t ( {x}^{*} )} ( 1 - {φ}_{2} ) & [ Equation 58 ] \\ {Z}_{2}^{″} = \frac{1}{2} \frac{Δ x}{Δ t} {C}_{2}^{n} + \frac{1}{2} \frac{Δ x}{δ t ( {x}^{*} )} {φ}_{2} {C}_{1}^{n} & [ Equation 59 ]\end{matrix}$$

Consequently, the equations used in the numerical models proposed under conditions as shown in FIG. 2 are Equations 38, 43 and 52.

As such, it is noted that when particles positioned at the nodes i (i≧2) reach the Cauchy boundary before Δt, equations used in the numerical models should be modified using Equations 57 to 59.

Through the foregoing, the method of analyzing contaminant transport under Cauchy boundary conditions using the improved Lagrangian-Eulerian method according to the present invention may be achieved.

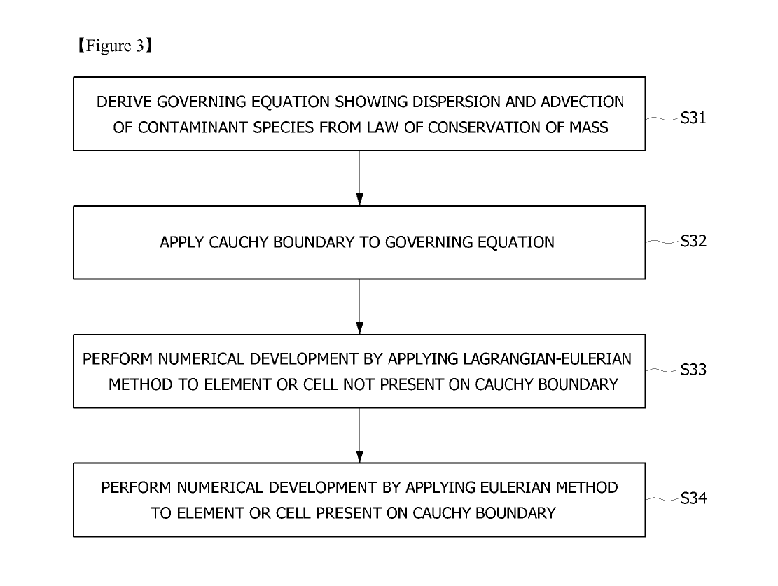

More specifically, FIG. 3 is a flowchart schematically illustrating the process of analyzing contaminant transport under Cauchy boundary conditions using the improved Lagrangian-Eulerian method according to an embodiment of the present invention, which is achieved based on the foregoing.

As illustrated in FIG. 3, the method of analyzing contaminant transport under Cauchy boundary conditions using the improved Lagrangian-Eulerian method according to the embodiment of the present invention largely includes deriving a governing equation which shows dispersion and advection of soluble non-reactive contaminant species in an aquifer from the law of conservation of mass (S31), as described with reference to Equations 1 to 9.

Subsequently, applying Cauchy boundary to the derived governing equation (S32) is performed, so that numerical development is carried out differently depending on the boundary conditions.

More specifically, performing numerical development by applying a Lagrangian-Eulerian method to those other than an element or cell present on the Cauchy boundary (S33) is carried out, as described with reference to Equations 10 to 26.

Also, performing numerical development by applying a Eulerian method to an element or cell present on the Cauchy boundary (S34) is carried out, as described with reference to Equations 27 to 59.

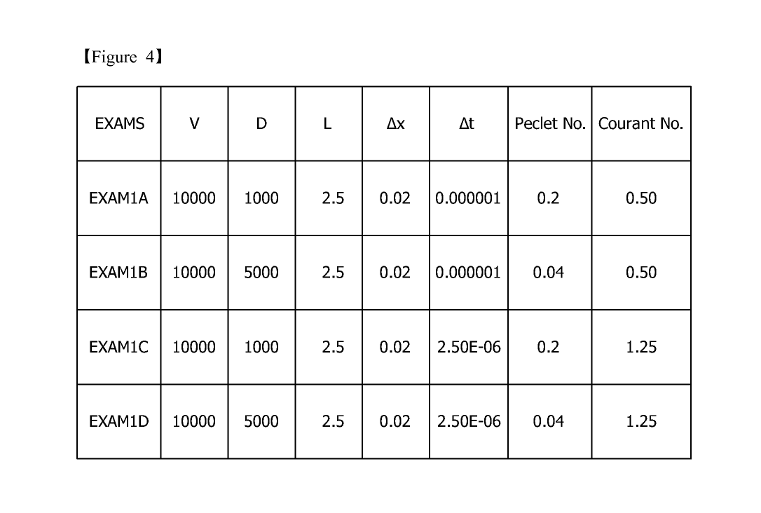

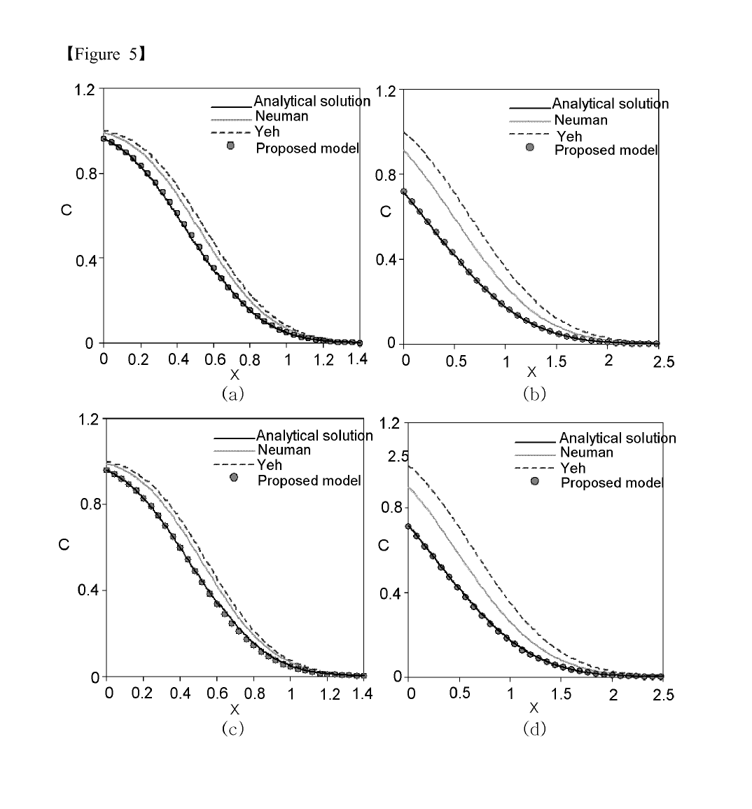

After performing the numerical development as above, the method according to the present invention may further include performing a simulation test to verify accuracy of numerical analysis, as will be described later with reference to FIGS. 4 and 5A to 5D.

Therefore, the present invention may provide an analysis system composed of an exclusive hardware, which is configured such that a series of processes including the above steps are executed.

Alternatively, the present invention preferably provides a program for executing a series of processes including the above steps through a computer, or provides a recording medium having such a program recorded therein.

Furthermore, the results of a simulation test for verifying performance of the method of analyzing contaminant transport under Cauchy boundary conditions using the improved Lagrangian-Eulerian method according to the present invention are described.

The present inventors performed numerical simulation of the case where the Peclet number is less than 1 in the numerical simulation including Cauchy boundary, in order to verify whether problems of a conventional Eulerian-Lagrangian method (Cited references 7 and 12) were overcome by the method of analyzing contaminant transport under Cauchy boundary conditions using the improved Lagrangian-Eulerian method according to the embodiment of the present invention.

In this case, comparative numerical models for use in the conventional Eulerian-Lagrangian method are models which are not substantially limited by Courant numbers and Peclet numbers upon using Dirichlet boundary, and are efficient and general models which may maintain accuracy even when large time intervals and space intervals are used under conditions of the Peclet numbers being high in the groundwater field (Cited references 7 and 12).

FIG. 4 is a table illustrating the input data applied to numerical simulation for verifying performance of the process of analyzing contaminant transport under Cauchy boundary conditions using the improved Lagrangian-Eulerian method according to the present invention.

More specifically, as illustrated in FIG. 4, the present inventors performed numerical simulations of the cases where the Peclet number is less than 1 under Cauchy boundary and Courant number is less than 1 (EXAM1A and EXAM1B) and is greater than 1 (EXAM1C and EXAM1D).

FIGS. 5A to 5D are graphs illustrating the numerical simulation results based on the input data of FIG. 4.

FIG. 5A illustrates EXAM1A of FIG. 4, FIG. 5B illustrates EXAM1B of FIG. 4, FIG. 5C illustrates EXAM1C of FIG. 4, and FIG. 5D illustrates EXAM1D of FIG. 4.

Thus, as illustrated in FIGS. 5A to 5D, in the case where Cauchy boundary is applied, when the Peclet number is less than 1, numerical models using the conventional Eulerian-Lagrangian method are different from analytical solutions. In particular, the two conventional models are increasingly different from the analytical solutions in proportion to a decrease in the Peclet number under the same Courant number.

However, when the Peclet number is less than 1, all the numerical models by the method of analyzing contaminant transport under Cauchy boundary conditions using the improved Lagrangian-Eulerian method according to the present invention are consistent with the analytical solutions, regardless of Courant numbers.

Ultimately, the method of analyzing contaminant transport under Cauchy boundary conditions using the improved Lagrangian-Eulerian method according to the present invention may be achieved through the foregoing.

The present invention may provide an exclusive hardware configured to execute the series of processes as above, or the present invention preferably provides a program for executing the series of processes as above through a computer, or provides a recording medium having such a program recorded therein.

As the method of analyzing contaminant transport under Cauchy boundary conditions using the improved Lagrangian-Eulerian method according to the embodiment of the present invention is achieved as above, this method is configured to analyze a new numerical matrix constructed in such a manner that the Eulerian method is applied to an element adjacent to Cauchy boundary conditions and the conventional Lagrangian-Eulerian method is applied to an internal element, thereby enabling accurate numerical analysis of contaminant transport at various Peclet numbers including particularly low Peclet numbers under Cauchy boundary conditions.

Moreover, according to the present invention, when the models at various Peclet numbers and Courant numbers are compared with numerical models based on the conventional Eulerian-Lagrangian method, the two conventional models are increasingly different from the analytical solutions in proportion to a decrease in the Peclet number under the same Courant number, but the numerical models according to the present invention are efficiently consistent with the analytical solutions regardless of the Peclet numbers and Courant numbers, thereby overcoming problems of the conventional Eulerian-Lagrangian method.

As described herein before, the present invention provides a method of analyzing contaminant transport under Cauchy boundary conditions using an improved Lagrangian-Eulerian method. According to the present invention, the method can solve problems of a conventional Lagrangian-Eulerian method able to analyze only high Peclet numbers in conventional methods for numerically analyzing contaminant transport in groundwater, thereby enabling accurate numerical analysis of contaminant transport at various Peclet numbers under Cauchy boundary conditions.

Also, according to the present invention, the method is configured to analyze a new numerical matrix constructed in such a manner that a Eulerian method is applied to an element adjacent to Cauchy boundary conditions and a conventional Lagrangian-Eulerian method is applied to an internal element, thereby enabling accurate numerical analysis of contaminant transport at various Peclet numbers including not only high Peclet numbers but also particularly low Peclet numbers under Cauchy boundary conditions.

Although the method of analyzing contaminant transport under Cauchy boundary conditions using the improved Lagrangian-Eulerian method according to the embodiments of the present invention is specified as above, the present invention is not limited only to the contents described in the above embodiments, and thus those having ordinary knowledge in the art to which the present invention belongs will appreciate that a variety of modifications, variations, additions and substitutions are possible depending on the needs for design and various other factors, without departing from the scope and spirit of the invention.

1. A method of analyzing contaminant transport under Cauchy boundary conditions using an improved Lagrangian-Eulerian method, which is configured to execute, on a computer, a series of processes for solving problems of a conventional Lagrangian-Eulerian method able to analyze only high Peclet numbers, by analyzing a new numerical matrix constructed in such a manner that a Eulerian method is applied to an element adjacent to the Cauchy boundary conditions and the conventional Lagrangian-Eulerian method is applied to an internal element, in order to numerically analyze contaminant transport in groundwater,
wherein the series of processes comprise:
deriving a governing equation showing dispersion and advection of contaminant species from a law of conservation of mass;
applying Cauchy boundary to the governing equation;
performing numerical development by applying a Lagrangian-Eulerian method to an element or cell not present on the Cauchy boundary; and
performing numerical development by applying a Eulerian method to an element or cell present on the Cauchy boundary, thus enabling accurate numerical analysis of contaminant transport not only at high Peclet numbers but also at low Peclet numbers under the Cauchy boundary conditions.

2. The method of claim 1, further comprising performing a simulation test to verify accuracy of numerical analysis, after performing the numerical development.

3. The method of claim 1, wherein the deriving the governing equation is carried out such that, assuming that groundwater flows only in an x-axis direction and θ is constant in an entire region, when θ is a volume of water per unit volume, C is a concentration of a solute, V is a seepage velocity, D is a dispersion coefficient, and a material derivative with respect to a concentration is defined as follows:
$$\begin{matrix}\frac{DC}{Dt} = \frac{\partial C}{\partial t} + \frac{\partial C}{\partial t} \frac{Dx}{Dt} \\ = \frac{\partial C}{\partial t} + \frac{\partial C}{\partial x} V\end{matrix}$$
the governing equation is determined by the following equation:
$$\frac{DC}{Dt} + C \frac{\partial V}{\partial x} - \frac{\partial }{\partial x} [ D \frac{\partial C}{\partial x} ] = 0$$
wherein C is not a concentration depending on time at a predetermined point but is a concentration depending on time in particles moving at a velocity V.

4. The method of claim 3, wherein, in the deriving the governing equation, an initial condition and a boundary condition for the governing equation are represented by the following equations:
$$C ( x , t ) {\vert}_{t = 0} = F ( x )$$
$$VC ( x , t ) - D \frac{\partial C ( x , t )}{\partial x} {\vert}_{x = 0} = V ( x = 0 , t ) f ( t )$$
$$D \frac{\partial C ( x , t )}{\partial x} {\vert}_{x = L} = 0$$
wherein F(x) is an initial concentration, f(t) is a concentration of a solute introduced through the Cauchy boundary, and L is a length of a medium.

5. The method of claim 4, wherein the performing the numerical development by applying the Lagrangian-Eulerian method is carried out by the following equation:
$$( \frac{[ M ]}{δ t ( {x}^{*} )} + θ ( [ S ] + [ V ] ) ) \{ {C}^{n + 1} \} = ( \frac{[ M ]}{δ t ( {x}^{*} )} - ( 1 - θ ) ( [ S ] + [ V ] ) ) \{ {C}^{*} \} + \{ B \}$$
wherein δt(x*) is a particle tracking time related to x*, θ is a time integral factor, {Cⁿ⁺¹} is a concentration vector at a current time, {C*} is a Lagrangian concentration vector, [M] is a matrix calculated from time differential, [S] is a matrix calculated from a dispersion term, [V] is a matrix calculated from a velocity term, and {B} is a vector related to boundary upon using a Eulerian-Lagrangian equation.

6. The method of claim 5, wherein, in the performing the numerical development by applying the Lagrangian-Eulerian method, [M], [S], [V] and {B} are calculated by the following equations:
$${M}_{ij} = {\sum }_{e ∈ {M}_{e}} {\int }_{L}^{ } {N}_{α}^{e} {N}_{β}^{e} d x$$
$${S}_{ij} = {\sum }_{e ∈ {M}_{e}} {\int }_{L}^{ } D \frac{d {N}_{α}^{e}}{d x} \frac{d {N}_{β}^{e}}{d x} d x$$
$${V}_{ij} = {\sum }_{e ∈ {M}_{e}} {\int }_{L}^{ } ( \frac{\partial V}{\partial x} ) {N}_{α}^{e} {N}_{β}^{e} d x$$
$${B}_{i} = {\sum }_{e ∈ {N}_{se}}^{ } {N}_{α}^{e} \hat{n} \cdot ( \frac{\partial C}{\partial x} )$$
wherein Mₑ indicates a set of elements having local nodes α-β consistent with nodes i-j, Nₛₑ indicates a set of element boundary surfaces having a local node α consistent with a node i, and N_{α}^{e} is a local Galerkin weighting function of an element e.

7. The method of claim 6, wherein the performing the numerical development by applying the Eulerian method to the element or cell present on the Cauchy boundary is carried out by the following equation:
$$( \frac{[ M ]}{Δ t} + θ ( [ S ] + [ E ] ) ) \{ {C}^{n + 1} \} = ( \frac{[ M ]}{Δ t} - ( 1 - θ ) ( [ S ] + [ E ] ) ) \{ {C}^{n} \} + \{ F \}$$
wherein Δt is a time interval, {Cⁿ} is a concentration vector at a past time, [E] is a matrix calculated from a velocity term, and {F} is a vector related to a case of using a Eulerian equation.

8. The method of claim 7, wherein, in the performing the numerical development by applying the Eulerian method, [E] and {F} are calculated by the following equations:
$${E}_{ij} = {\sum }_{e ∈ {M}_{e}}^{ } {\int }_{L}^{ } \frac{V \partial {W}_{α}^{e}}{\partial x} {N}_{β}^{e} d x$$
$${F}_{i} = - {\sum }_{e ∈ {N}_{se}}^{ } {N}_{α}^{e} \hat{n} \cdot ( VC - D \frac{\partial C}{\partial x} ) .$$
(Where, W_{α}^{e} is an upstream weighting function of an element e.)

9. A computer-readable recording medium, having recorded therein a program for executing a series of processes which enable accurate numerical analysis of contaminant transport not only at high Peclet numbers but also at low Peclet numbers under Cauchy boundary conditions, through a computer, using the method of claim 1.

10. An analysis system, which is configured to execute the method of claim 1 so as to enable accurate numerical analysis of contaminant transport not only at high Peclet numbers but also at low Peclet numbers under Cauchy boundary conditions.
